(19) United States
(12) Patent Application Publication
(10) Pub. No.: US 2008/0278451 A1
(43) Pub. Date: Nov. 13, 2008

(54) TOUCH-PANEL-INTEGRATED LIQUID CRYSTAL DISPLAY AND METHOD OF DRIVING THE SAME

(75) Inventor: Ki-chan LEE, Chungcheongnam-do (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/927,775

(22) Filed: Oct. 30, 2007

(30) Foreign Application Priority Data
May 7, 2007 (KR) 10-2007-0044249

(51) Int. Cl. G06F 3/041

(52) U.S. Cl. 345/173

(57) ABSTRACT

A touch-panel-integrated liquid crystal display (“LCD”) which prevents malfunction of a sensor by decoupling coupling noise, and a method of driving the touch-panel-integrated LCD. The touch-panel-integrated LCD includes a plurality of first lines which extend in a first direction, a plurality of second lines which extend in a second direction that intersects the first direction, a plurality of thin film transistors which are respectively disposed at interconnections between the first lines and the second lines, a first comparator which includes first and second nodes, a first sensor line which is connected to the first node, extends in the same direction as the first lines, and transmits a touch signal corresponding to the first direction, and a first decoupler which is connected between the second node and one of the first lines and decouples coupling noise present in the touch signal corresponding to the first direction.

This application claims priority to Korean Patent Application No. 10-2007-0044249, filed on May 7, 2007, and all the benefits accruing therefrom under 35 U.S.C. §119, the contents of which in its entirety are herein incorporated by reference.

### BACKGROUND OF THE INVENTION

1. Field of the Invention

The present invention relates to a touch-panel-integrated liquid crystal display (“LCD”), and, more particularly, to a touch-panel-integrated LCD which can prevent malfunction of a sensor by decoupling coupling noise, and a method of driving the touch-panel-integrated LCD.

2. Description of the Related Art

Touch panels are widely used as input devices in display devices. Touch panels are devices which can receive information regarding a position on a screen pressed by a user with a pen or a finger, and can thus enable a user to easily input various information onto the screen.

In order to address a number of problems associated with the thickness and size of touch panels, touch-panel-integrated liquid crystal displays (“LCDs”), which are LCDs including touch panels, have been developed. Since the thickness of touch sensors is reduced by integrating a touch panel into an LCD, touch-panel-integrated LCDs are easy to manufacture as thin flat displays. In addition, since touch-panel-integrated LCDs do not require an additional module assembly processes, it is possible to increase the production of touch panel-LCDs.

The operation of touch-panel-integrated LCDs will now be described. When external pressure is applied, a common electrode on a common electrode display panel is placed in contact with a sensor electrode on a thin film transistor (“TFT”) display panel, and thus, a predetermined voltage is applied to a sensor line. Thereafter, the predetermined voltage is applied to a sensor via the sensor line. Then, the sensor outputs a signal having a predetermined level, and determines the location of a touch point where the external pressure is applied.

A common voltage may be distorted by a coupling between a data line on a TFT display panel and a common electrode on a common electrode display panel, this phenomenon is referred to as coupling noise. Coupling noise severely distorts a common voltage when a data voltage applied to a data line on a TFT display panel varies. The common voltage distorted by the coupling noise is applied to a sensor via a sensor line, which may cause the sensor to mistakenly detect that an external pressure has been applied when no external pressure has been applied, or cause the sensor to inaccurately detect the coordinates of a touch point where external pressure has been applied.

In order to decouple coupling noise, a dummy sensor line may be used. Specifically, a dummy sensor line is provided to extend in the same direction as a sensor line. Then, coupling noise that the dummy sensor line and the sensor line have in common is decoupled using a comparator which is connected to both the dummy sensor line and the sensor line. However, when the number of sensor lines is doubled due to the dummy sensor line, the aperture ratio decreases.

### BRIEF SUMMARY OF THE INVENTION

The present invention has made an effort to solve the above stated problems, and an aspect of the present invention provides a touch-panel-integrated liquid crystal display (“LCD”) which prevents malfunction of a sensor by decoupling coupling noise, and reduces the decrease in aperture ratio resulting from the use of a dummy sensor line.

Another aspect of the present invention provides a method of driving a touch-panel-integrated LCD which prevents malfunction of a sensor by decoupling coupling noise, and reduces the decrease in aperture ratio resulting from the use of a dummy sensor line.

The above and other aspects of the present invention will become apparent to one of ordinary skill in the art to which the present invention pertains by referencing the detailed description of the present invention given below.

In an exemplary embodiment, the present invention provides a touch-panel-integrated LCD including a plurality of first lines which extend in a first direction, a plurality of second lines which extend in a second direction that intersects the first direction, a plurality of thin film transistors (“TFTs”) which are respectively disposed at interconnections between the first lines and the second lines, a first comparator which includes first and second nodes, a first sensor line which is connected to the first node, extends in a same direction as the first lines, and transmits a touch signal corresponding to the first direction, and a first decoupler which is connected between the second node and one of the first lines and decouples coupling noise present in the touch signal corresponding to the first direction.

In another exemplary embodiment, the present invention provides a touch-panel-integrated LCD including a plurality of first lines which extend in a first direction, a plurality of second lines which extend in a second direction that intersects the first direction, a plurality of TFTs which are respectively disposed at interconnections between the first lines and the second lines, a first comparator which includes first and second nodes, a first sensor line which is connected to the first node, extends in a same direction as the first lines, and transmits a touch signal corresponding to the first direction, a common electrode, and a first decoupler which is connected between the second node and the common electrode, and decouples coupling noise present in a common voltage that is applied to the common electrode.

In another exemplary embodiment, the present invention provides a touch-panel-integrated LCD including a plurality of first lines which extend in a first direction, a plurality of second lines which extend in a second direction that intersects the first direction, a plurality of TFTs which are respectively disposed at interconnections between the first lines and the second lines, a first comparator which includes first and second nodes, a second comparator which includes third and fourth nodes, a first sensor line which is connected to the first node, extends in a same direction as the first lines, and transmits a touch signal corresponding to the first direction, a second sensor line which is connected to the third node, extends in a same direction as the second lines, and transmits a touch signal corresponding to the second direction, a first decoupler which is connected between the second node and one of the first lines and decouples coupling noise present in the touch signal corresponding to the first direction, and a second decoupler which is connected between the fourth node and one of the second lines, and decouples coupling noise present in the touch signal corresponding to the second direction.

In another exemplary embodiment, the present invention provides a method of driving a touch-panel-integrated LCD, the method including providing a touch-panel-integrated LCD including a plurality of first lines which extend in a first direction, a plurality of second lines extend in a second direction that intersects the first direction, a plurality of TFTs which are respectively disposed at interconnections between the first lines and the second lines, a first comparator which comprises first and second nodes, a first sensor line which is connected to the first node, extends in the first direction, and transmits a touch signal corresponding to the first direction, and a first decoupler which is connected between the second node and one of the first lines and decouples coupling noise present in the touch signal corresponding to the first direction, applying external pressure to a touch panel of the touch-panel-integrated LCD, generating a signal which is a same as the coupling noise present in the touch signal corresponding to the first direction, and outputting the decoupled touch signal by applying the generated signal to an input terminal of the first comparator.

In another exemplary embodiment, the present invention provides a method of driving a touch-panel-integrated LCD, the method including providing a touch-panel-integrated LCD including a plurality of first lines which extend in a first direction, a plurality of second lines extend in a second direction that intersects the first direction, a plurality of TFTs which are respectively disposed at interconnections between the first lines and the second lines, a first comparator which includes first and second nodes, a first sensor line which is connected to the first node, extends in the first direction, and transmits a touch signal corresponding to the first direction, a common electrode, and a third decoupler which is connected between the second node and the common electrode, and decouples coupling noise present in a common voltage that is applied to the common electrode, applying external pressure to a touch panel of the touch-panel-integrated LCD, reducing the common voltage, and outputting the decoupled common voltage by applying the reduced common voltage to an input terminal of the first comparator.

### BRIEF DESCRIPTION OF THE DRAWINGS

The above and/or other aspects, features and advantages of the present invention will become more apparent from the following detailed description when taken in conjunction with the accompanying drawings, in which:

FIG. 1 is a circuit diagram showing an exemplary embodiment of a touch-panel-integrated liquid crystal display (“LCD”) according to the present invention.

FIG. 2 is a circuit diagram illustrating an exemplary embodiment of an operation of the touch-panel-integrated LCD illustrated in FIG. 1 according to the present invention;

FIG. 3 is an equivalent circuit diagram of FIG. 2, and illustrates an exemplary embodiment of the decoupling of coupling noise by the touch-panel-integrated LCD illustrated in FIG. 1 according to the present invention;

FIG. 4 is a circuit diagram shoving another exemplary embodiment of a touch-panel-integrated LCD according to the present invention;

FIG. 5 is a circuit diagram showing another exemplary embodiment of a touch-panel-integrated LCD according to the present invention;

FIG. 6 is a circuit diagram showing another exemplary embodiment of a touch-panel-integrated LCD according to the present invention;

FIG. 7 is a circuit diagram showing another exemplary embodiment of a touch-panel-integrated LCD according to the present invention;

FIG. 8 is a circuit diagram illustrating an exemplary embodiment of an operation of the touch-panel-integrated LCD illustrated in FIG. 7 according to the present invention;

FIG. 9 is an equivalent circuit diagram of FIG. 8, and illustrates an exemplary embodiment of the decoupling of coupling noise by the touch-panel-integrated LCD illustrated in FIG. 7 according to the present invention;

FIG. 10 is a circuit diagram showing another exemplary embodiment of a touch-panel-integrated LCD according to the present invention; and

FIG. 11 is a circuit diagram showing another exemplary embodiment of a touch-panel-integrated LCD according to the present invention.

### DETAILED DESCRIPTION OF THE INVENTION

The present invention will now be described more fully hereinafter with reference to the accompanying drawings, in which exemplary embodiments of the present invention are illustrated. The invention may, however, be embodied in different forms and should not be construed as limited to the embodiments set forth herein. Rather, these embodiments are provided so that this disclosure will be thorough and complete, and will fully convey the scope of the present invention to those skilled in the art.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” other elements or features would then be oriented “above” or “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to limit the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

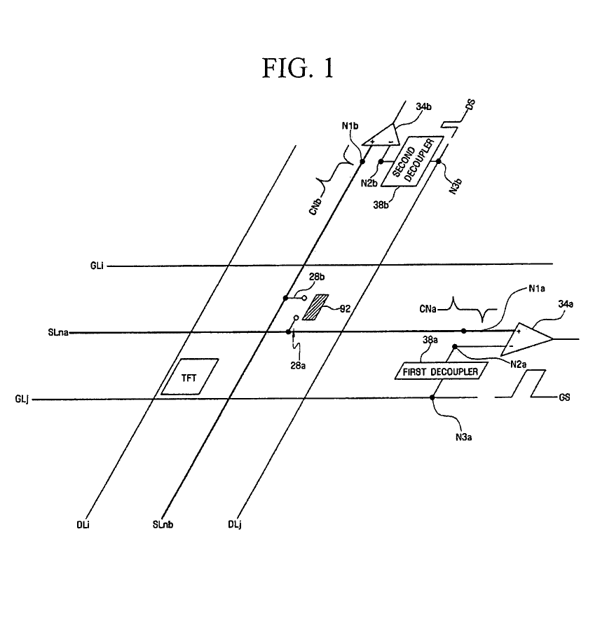

A touch-panel-integrated liquid crystal display (“LCD”) according to an exemplary embodiment of the present invention and a method of driving the touch-panel-integrated LCD according to an embodiment of the present invention will hereinafter be described in detail with reference to FIGS. 1 through 3.

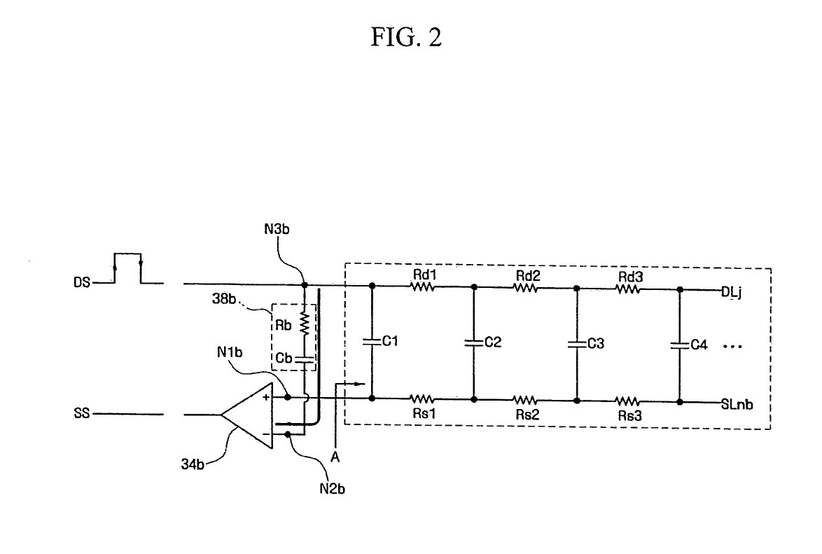

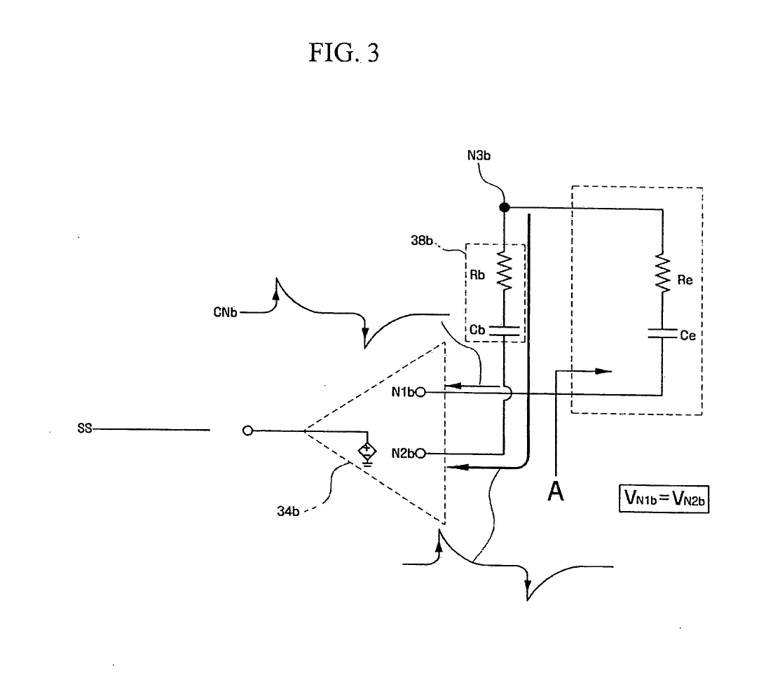

FIG. 1 is a circuit diagram showing an exemplary embodiment of a touch-panel-integrated LCD according to the present invention, FIG. 2 is a circuit diagram illustrating an exemplary embodiment of an operation of the touch-panel-integrated LCD illustrated in FIG. 1, and FIG. 3 is an equivalent circuit diagram of FIG. 2 illustrates an exemplary embodiment of the decoupling of coupling noise by the touch-panel-integrated LCD illustrated in FIG. 1.

Referring to FIG. 1, the touch-panel-integrated LCD includes gate lines GLi and GLj, data lines DLi and DLj, a thin film transistor (“TFT”), a first sensor line SLna, a second sensor line SLnb, a first sensor electrode 28a, a second sensor electrode 28b, a sensor spacer 92, a first comparator 34a, a second comparator 34b, a first decoupler 38a, and a second decoupler 38b, where i and j are arbitrary natural numbers and satisfy the equation: j=i+1.

The gate lines GLi and GLj and the data lines DLi and DLj are formed on an insulating substrate of a TFT display panel. The gate lines GLi and GLj intersect the data lines DLi and DLj.

According to an exemplary embodiment, the TFT may be disposed at each of the interconnections between the gate lines GLi and GLj and the data lines DLi and DLj. The TFT includes three terminals (i.e., a gate electrode, a source electrode, and a drain electrode). The TFT is a switching device that flows a current between the source electrode and the drain electrode when a voltage is applied to the gate electrode.

According to an exemplary embodiment, the first sensor line SLna extends along the same direction as the gate lines GLi and GLj, and transmits a touch signal corresponding to a first direction to a first node N1a of the first comparator 34a. Likewise, the second sensor line SLnb extends along the same direction as the data lines DLi and DLj, and transmits a touch signal corresponding to a second direction to a third node N1b of the second comparator 34b.

The first and second sensor electrodes 28a and 28b respectively protrude from the first and second sensor lines SLna and SLnb. The first and second sensor electrodes 28a and 28b are the terminals of respective corresponding touch panel sensors.

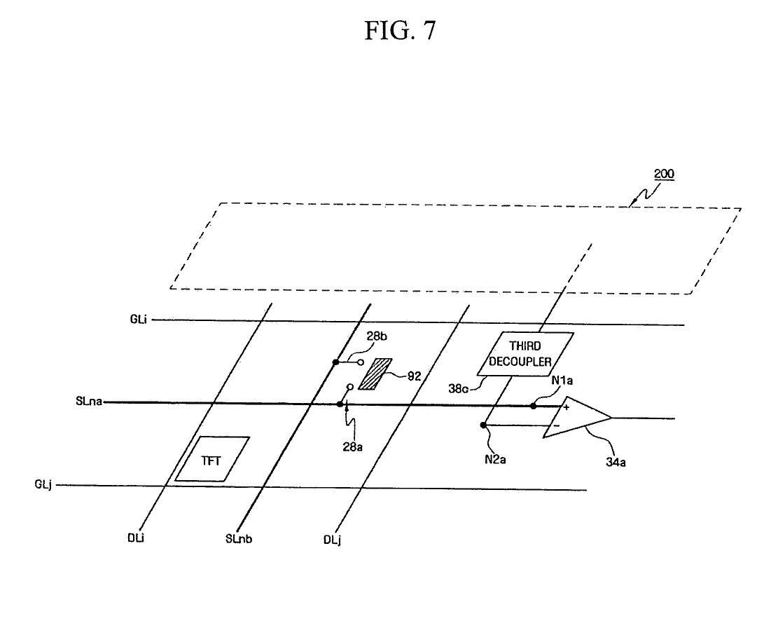

The sensor spacer 92 is formed on a common electrode display panel 200 (as shown in FIG. 7, for example). The sensor spacer 92 is separated from the TFT display panel at an early stage of operation when no external pressure is applied thereto.

When external pressure is applied, a current flows between the first and second sensor electrodes 28a and 28b and a common electrode via the sensor spacer 92. As a result, a predetermined voltage is applied to the first and second sensor lines SLna and SLnb as a touch signal. The predetermined voltage is transmitted to the first and second comparators 34a and 34b so that location information regarding the location of a touch point, from which the external pressure is applied, can be provided to a sensor.

That is, the first sensor line SLna and the first sensor electrode 28a provide a sensor with a latitudinal coordinate of the touch point, whereas the second sensor line SLna and the second sensor electrode 28b provide the sensor with a longitudinal coordinate of the touch point.

The first and second comparators 34a and 34b are connected to input terminals of respective corresponding sensors (not shown) to which signals are input via the first and second sensor lines SLna and SLnb. The first comparator 34a amplifies the difference between the voltage of the first node N1a and the voltage of a second node N2a, and outputs the result of the amplification. The second comparator 34b amplifies a difference between the voltage of the third node N1b and the voltage of a fourth node N2b, and outputs the result of the amplification.

According to an exemplary embodiment, the first decoupler 38a may be connected between the second node N2a of the first comparator 34a and the gate line GLj, which is adjacent to the first sensor line SLna to which the first comparator 34a is connected, however, the present invention is not limited hereto. Alternatively, according to an exemplary embodiment, the first decoupler 38a may be connected to another gate line instead of gate line GLj. However, if the first decoupler 38a is connected to a closed gate line such as gate line GLj, the decrease in aperture ratio that results from the installation of the first decoupler 38a may be reduced. According to an exemplary embodiment, the first decoupler 38a may be connected to the gate line GLj via a gate signal input node N3a, but the present invention is not limited hereto. Alternatively, the first decoupler 38a may be connected an arbitrary node on gate line GLj instead of the gate signal input Node N3a. However, if the first decoupler 38a is connected to the gate line GLj via the gate signal input node N3a, the decrease in aperture ratio that results from the installation of the first decoupler 38a may be reduced.

Likewise, the second decoupler 38b is connected between the fourth node N2b of the second comparator 34b and the data line DLj, which is adjacent to the second sensor line SLnb to which the second comparator 34b is connected. The structures and the functions of the first and second decouplers 38a and 38b will be described later in further detail with reference to FIGS. 2 and 3.

The operating principles of the flat panel-integrated LCD illustrated in FIG. 1 will hereinafter be described in detail with reference to FIGS. 2 and 3.

FIG. 2 is a circuit diagram illustrating an exemplary embodiment of an operation of the touch-panel-integrated LCD illustrated in FIG. 1, and FIG. 3 is an equivalent circuit diagram of FIG. 2 illustrating an exemplary embodiment of the decoupling of coupling noise by the touch-panel-integrated LCD illustrated in FIG. 1, according to the present invention.

Referring to FIG. 1, the first decoupler 38a is connected between the gate line GLj and the first comparator 34a, and the second decoupler 38b is connected between the data line DLj and the second comparator 34b. There are two circuits. One circuit is constituted by the gate line GL, the first sensor line SLna, the first comparator 34a, and the first decoupler 38a connected between the gate line GLj and the first comparator 34a. The other circuit is constituted by the data line DLj, the second sensor line SLnb, the second comparator 34b and the second decoupler 38b connected between the data line DLj and the second comparator 34b. In here, GS and DS respectively mean gate signal and data signal. Also CNa and CNb are respectively the touch signal including the added coupling noise in each circuit. Since the operation of the first decoupler 38a are the same as the operation of the second decoupler 38b, only the operation of a circuit constituted by the data line DLj, the second sensor line SLnb, the second comparator 34b, and the second decoupler 38b connected between the data line DLj and the second comparator 34b will only be described in detail for the purpose of explanation.

A variation in a data signal DS causes a coupling between the data line DLj and the second sensor line SLnb and therefore produces coupling noise at the second sensor line SLnb. The coupling noise is added to a touch signal, and then, the touch signal including the added coupling noise CNb is applied to the third node N1b. That is, the touch signal is distorted due to the coupling noise, and the distorted touch signal is transmitted to the third node N1b.

The data line DLj and the second sensor line SLnb when they are coupled may be modeled as an electrical circuit according to the result of analysis of the coupling noise. According to an exemplary embodiment, if the result of the analysis of the coupling noise indicates that the coupling noise is a transient response of a primary circuit, the data line DLj and the second sensor line SLnb may be modeled as a primary circuit including a resistor and a capacitor. Alternatively, if the result of the analysis of the coupling noise indicates that the coupling noise is a transient response of a secondary circuit, the data line DLj and the second sensor line SLnb may be modeled as a secondary circuit including a resistor, a capacitor, and an inductor. When the data line DLj and the second sensor line SLnb are modeled as an electrical circuit, the electrical circuit may be classified into a primary circuit or a secondary circuit according to the degree of a differential equation of the electrical circuit. A primary circuit includes a resistor and an inductor or a capacitor only, whereas a secondary circuit includes a resistor, an inductor, and a capacitor. A transient response is a signal output while an electric field returns to its steady normal state after being placed in an abnormal state due to external impact. FIGS. 2 and 3 illustrate the situation when coupling noise is interpreted as a transient response of a primary circuit. Referring to FIG. 2, a circuit seen from point A illustrates the data line DLj and the second sensor line SLnb, between which a coupling has occurred. The data line DLj includes resistors Rd1, Rd2, and Rd3, and the second sensor line SLnb includes resistors Rs1, Rs2, and Rs3. Coupling capacitors C1, C2, and C3 are disposed between the data line DLj and the second sensor line SLnb.

The circuit seen from point A may be represented by an equivalent circuit includes an equivalent resistor and an equivalent capacitor. FIG. 3 illustrates an equivalent circuit of the circuit seen from point A. Referring to FIG. 3, the equivalent circuit includes a resistor Re and a capacitor Ce. The second comparator 34b of FIG. 2 is illustrated in FIG. 3 as an ideal operational amplifier, and, particularly, as a voltage-controlled voltage source where V_{N1b} is equal to V_{N2B}.

Referring to FIG. 3, according to an exemplary embodiment, the second decoupler 38b may have the same properties as an electrical circuit constituted by the data line DLj and the second sensor line SLnb between which a coupling has occurred. If the data line DLj and the second sensor line SLnb are modeled as an impedance circuit, the second decoupler 38b may have the same impedance as the impedance circuit.

According to an exemplary embodiment, when the data line DLj and the second sensor line SLnb, between which a coupling has occurred, are modeled as a primary circuit including the equivalent resistor Re and the equivalent capacitor Ce in consideration that coupling noise can be interpreted as a transient response of a primary circuit, a second decoupling resistor Rb having the same resistance as the equivalent resistor Re and a second decoupling capacitor Cb having the same capacitance as the equivalent capacitor Ce may be provided.

Since the second decoupler 38b has the same properties as the circuit constituted by the data line DLj and the second sensor line SLnb when they are coupled, the second decoupler 38b responds to a variation in a data signal DS in the same manner as the circuit constituted by the data line DLj and the second sensor line SLnb between which a coupling has occurred. That is, a signal that is the same as coupling noise generated to the second sensor line SLnb, as a result of the coupling between the data line DL and the second sensor line SLnb, is applied to the fourth node N2b. The second comparator 34b removes a signal component that is the same as the coupling noise applied to the fourth node N2b from a distorted sensor line signal applied to the third node N1b, and then outputs the resulting sensor line signal, this process is referred to as common mode rejection.

In this manner, coupling noise present in a sensor line can be decoupled. Since no dummy sensor line is used to decouple coupling noise, it is possible to prevent aperture ratio from decreasing due to the installation of a dummy sensor line.

Referring to FIG. 1, the first decoupler 38a is connected between the second node N2a of the first comparator 34a and a single gate line, i.e., the gate line DLj, and the second decoupler 38b is connected between the fourth node N2b of the second comparator 34b and a single data line, i.e., the data line DLj. However, the present invention is not limited hereto. That is, a plurality of first decouplers 38a may be provided, wherein each of the first decouplers 38a is disposed between the second node N2a of the first comparator 34a and not only the gate line GLj but also other gate lines. Likewise, a plurality of second decouplers 38b may be provided, wherein each of the second decouplers 38b is disposed between the fourth node N2b of the second comparator 34b and not only the data line DLj but also other data lines.

According to an exemplary embodiment, assume that a number of first decoupler 38a is provided, and that each of the first decouplers 38a is disposed between the second node N2a of the first comparator 34a and a corresponding gate line. In this case, a voltage is sequentially applied to a plurality of gate lines respectively corresponding to the first decouplers 38a. A variation in the voltage of each of the plurality of gate lines results in coupling noise at the first sensor line SLna. The coupling noise caused by the plurality of gate lines, respectively, may be decoupled by the respective first decouplers 38a.

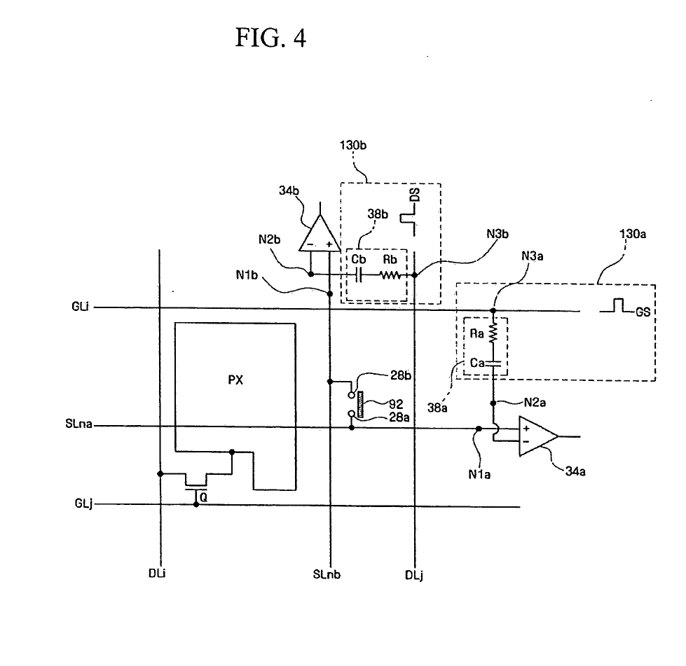

FIG. 4 is a circuit diagram showing another exemplary embodiment of a touch-panel-integrated LCD according to the present invention. In here, PX is a pixel electrode. Referring to FIG. 4, the touch-panel-integrated LCD includes gate lines GLi and GLj, data lines DLi and DLj, a thin film transistor (“TFT”) Q, a first sensor line SLna, a second sensor line SLnb, a first comparator 34a, a second comparator 34b, a first decoupler 38a, a second decoupler 38b, a gate driver integrated circuit (“IC”) 130a, and a source driver IC 130b.

According to an exemplary embodiment, the first decoupler 38a and the second decoupler 38b may be respectively integrated into the gate driver IC 130a and the source driver IC 130b.

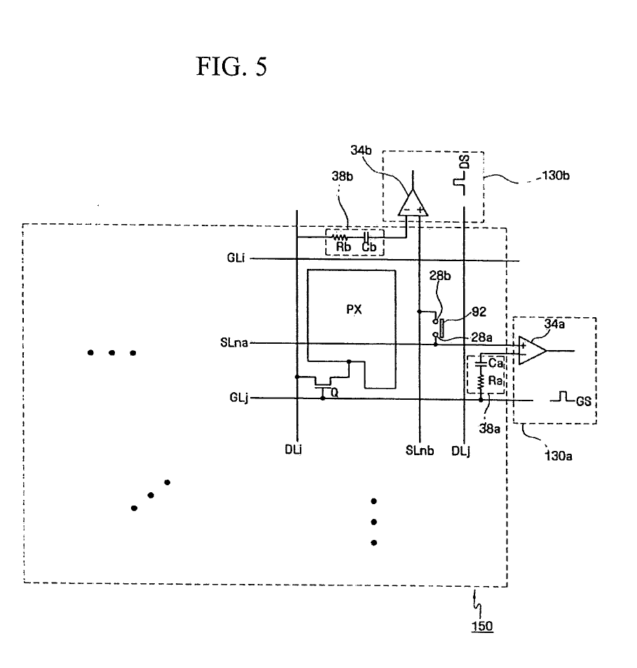

FIG. 5 is a circuit diagram showing another exemplary embodiment of a touch-panel-integrated LCD according to the present invention. Referring to FIG. 5, the touch-panel-integrated LCD includes gate lines GLi and GLj, data lines DLi and DLj, a TFT Q, a first sensor line SLna, a second sensor line SLnb, a first comparator 34a, a second comparator 34b, a first decoupler 38a, and a second decoupler 38b.

According to an exemplary embodiment, the first decoupler 38a and the second decoupler 38b are disposed on a substrate 150. A decoupling resistor may be realized by interconnections, and a decoupling capacitor may be realized using a method similar to that used to realize a storage capacitor in a panel.

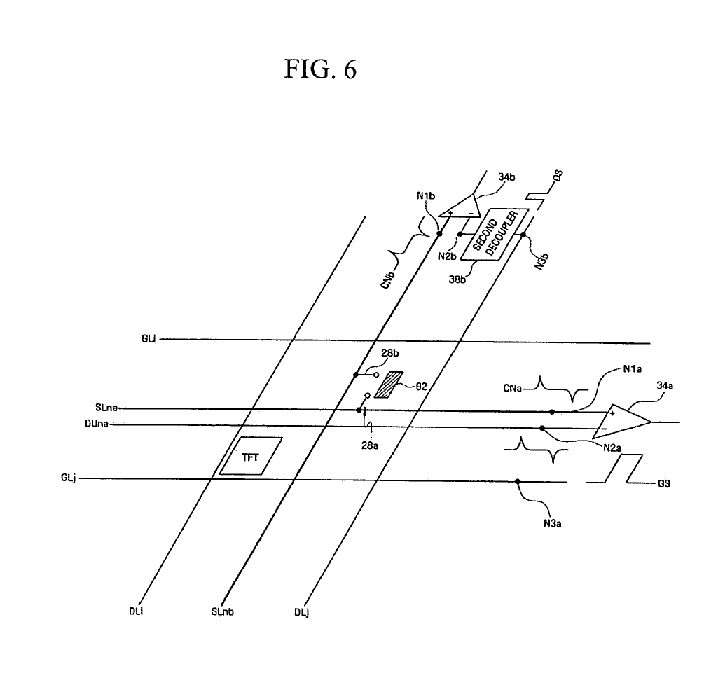

FIG. 6 is a circuit diagram showing another exemplary embodiment of a touch-panel-integrated LCD according to the present invention. Referring to FIG. 6, the touch-panel-integrated LCD includes gate lines GLi and GLj, data lines DLi and DLj, a TFT, a first sensor line SLna, a second sensor line SLnb, a first sensor electrode 28a, a second sensor electrode 28b, a sensor spacer 92, a first comparator 34a, a second comparator 34b, a first dummy sensor line DUna, and a second decoupler 38b.

The first dummy sensor line DUna extends in the same direction as the first sensor line SLna. The same coupling noise as that generated in the first sensor line SLna may be generated in the first dummy sensor line DUna. Coupling noise may be removed from the output of the first comparator 34a.

According to an exemplary embodiment, the second decoupler 38b may be integrated into a driver IC, as described in the embodiment of FIG. 4, or may be formed on a substrate, as described in the embodiment of FIG. 5.

A touch-panel-integrated LCD showing another exemplary embodiment of the present invention, and a method of driving the touch-panel-integrated LCD according to an exemplary embodiment of the present invention will hereinafter be described in detail with reference to FIGS. 7 through 9.

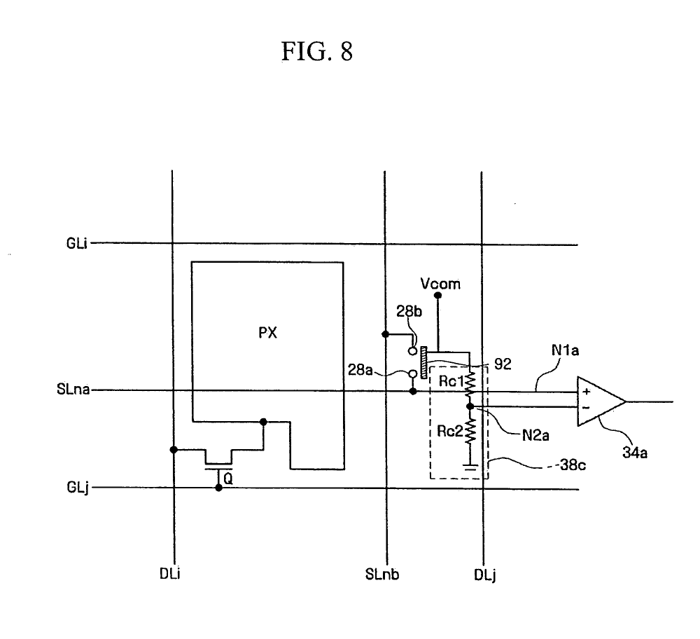

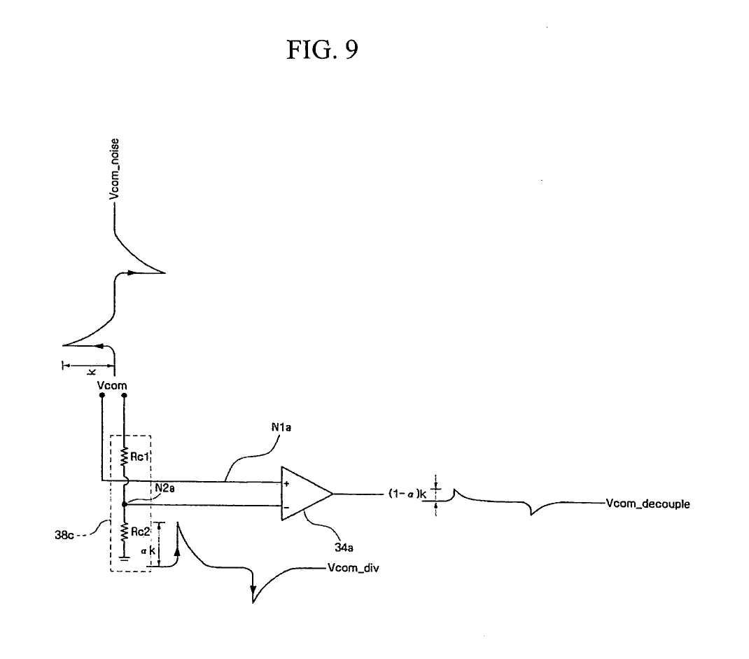

FIG. 7 is a circuit diagram showing another exemplary embodiment of a touch-panel-integrated LCD according to the present invention, FIG. 8 is a circuit diagram illustrating an exemplary embodiment of an operation of the touch-panel-integrated LCD illustrated in FIG. 7, and FIG. 9 is an equivalent circuit diagram of FIG. 8, illustrates an exemplary embodiment of the decoupling of coupling noise by the touch-panel-integrated LCD illustrated in FIG. 7.

Referring to FIG. 7, the touch-panel-integrated LCD includes gate lines GLi and GLj, data lines DLi and DLj, a TFT, a first sensor line SLna, a second sensor line SLnb, a first sensor electrode 28a, a second sensor electrode 28b, a sensor spacer 92, a first comparator 34a, a second comparator 34b, and a third decoupler 38C.

According to the exemplary embodiment shown in FIG. 7 there is only one decoupler (i.e., the third decoupler 38C) connected between the first comparator 34a and a common electrode on a common electrode display panel 200, however the present invention is not limited hereto. In addition, a fourth decoupler may also be connected between the second comparator 34b and the common electrode on the common electrode display panel 200. Since the operation of the fourth decoupler are the same as the operation of the third decoupler 38C, the operation of a circuit constituted by the first sensor SLna, the common electrode display panel 200, the first comparator 34a, and the third decoupler 38C will only be described for the purpose of explanation.

When external pressure is applied, a current flows between the first sensor electrode and a common electrode on the sensor spacer 92, and a common voltage applied to the common electrode is transmitted to a first node N1a of the first comparator 34a via the first sensor line SLna. The common voltage includes coupling noise mainly generated by a coupling between the data line DLj and a common electrode. Therefore, the coupling noise is applied to the first node N1a of the first comparator 34a. Referring to FIG. 9, reference character Vcom_noise denotes a common voltage with coupling noise.

The third decoupler 38C is connected between a second node N2a of the first comparator 34a and the common electrode on the common electrode display panel 200. The third decoupler 38C includes a circuit which reduces a common voltage applied to the common electrode on the common electrode display panel 200 and then applies the to reduced common voltage to the second node N2a of the first comparator 34a.

The predetermined circuit may be a voltage divider. Referring to FIG. 8, the circuit including resistors Rc1 and Rc2 which are connected in series is one of the voltage divider.

Referring to FIG. 9, reference character Vcom_div denotes a common voltage which is obtained by reducing the common voltage using a voltage divider. The common voltage may be reduced the ratio α, where α is a constant within the range of 0 and 1, and satisfies the equation: α=Rc2/(Rc1+Rc2). When the level of coupling noise present in Vcom_noise is k, the level of coupling noise present in Vcom_div is α*k, which is less than k. Vcom_div is applied to the second node N2a of the first comparator 34a.

The first comparator 34a subtracts the reduced common voltage Vcom_div from the common voltage with coupling noise Vcom_noise, and outputs the result of the subtraction, Vcom_decouple. When the level of coupling noise present in Vcom_noise is k, the level of coupling noise present in Vcom_decouple is (1−α)*k.

The constant α may be set to an arbitrary value within the range of 0 and 1. The closer the constant α is to 1, the more accurately the third decoupler 38C can decouple coupling noise. However, the closer the constant α is to 1, the weaker the output of the first comparator 34a (i.e., a signal input to a sensor) becomes.

According to an exemplary embodiment, the third decoupler 38C can decouple coupling noise present in a common voltage. Since no dummy sensor line is used to decouple coupling noise, it is possible to decouple coupling noise without causing the aperture ratio to decrease due to the installation of a dummy sensor line.

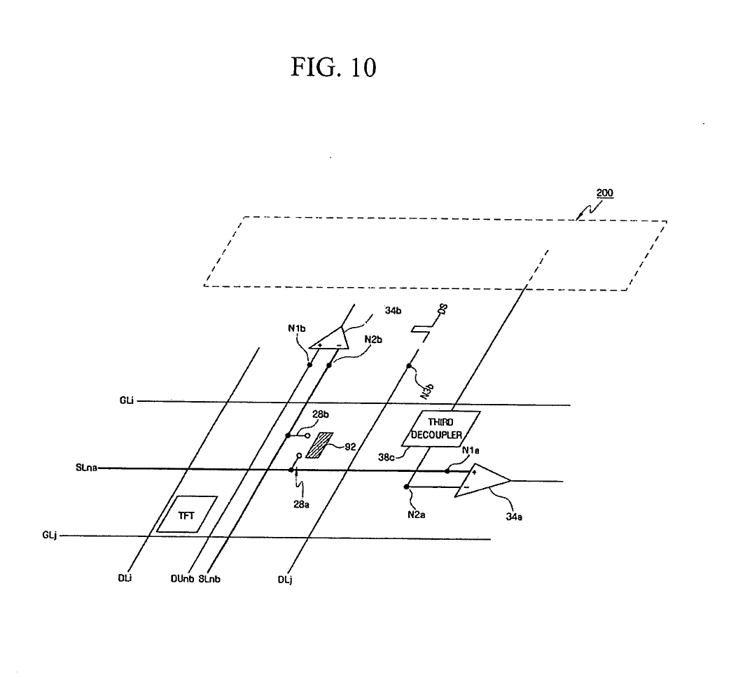

FIG. 10 is a circuit diagram showing another exemplary embodiment of a touch-panel-integrated LCD according to the present invention. Referring to FIG. 10, the touch-panel-integrated LCD includes gate lines GLi and GLj, data lines DLi and DLj, a TFT, a first sensor line SLna, a second sensor line SLnb, a first comparator 34a, a second comparator 34b, a second dummy sensor line DUna, and a third decoupler 38C.

The second dummy sensor line DUnb extends in the same direction as the second sensor line SLnb. The sane coupling noise as that generated at the second sensor line SLnb may be generated at the second dummy sensor line DUnb. Coupling noise may be removed from the output of the second comparator 34b.

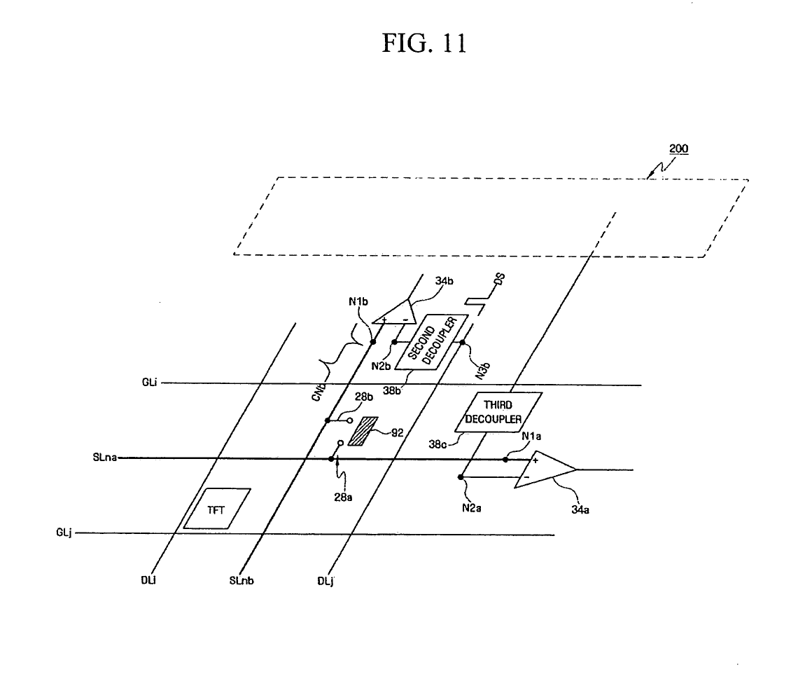

FIG. 11 is a circuit diagram of a touch-panel-integrated LCD according to another exemplary embodiment of the present invention. Referring to FIG. 11, the touch-panel-integrated LCD includes gate lines GLi and GLj, data lines DLi and DLj, a TFT, a first sensor line SLna, a second sensor line SLnb, a first comparator 34a, a second comparator 34b, a second decoupler 38b, and a third decoupler 38C.

The second decoupler 38b may be integrated into a driver IC, as described in the exemplary embodiment of FIG. 4, or may be formed on a substrate, as described in the exemplary embodiment of FIG. 5.

As described above, according to the present invention, it is possible to prevent malfunction of a sensor by decoupling coupling noise. In addition, it is possible to reduce a decrease in aperture ratio resulting from the installation of a dummy sensor line for decoupling coupling noise.

While the present invention has been shown and described with reference to some exemplary embodiments thereof, it should be understood by those of ordinary skill in the art that various changes in form and details may be made therein without departing from the spirit and the scope of the present invention as defined by the appending claims.

What is claimed is:

1. A touch-panel-integrated liquid crystal display comprising:
a plurality of first lines which extend in a first direction;
a plurality of second lines which extend in a second direction that intersects the first direction;
a plurality of thin film transistors which are respectively disposed at interconnections between the first lines and the second lines;
a first comparator which comprises first and second nodes;
a first sensor line which is connected to the first node, extends in a same direction as the first lines, and transmits a touch signal corresponding to the first direction; and
a first decoupler which is connected between the second node and one of the first lines and decouples coupling noise present in the touch signal corresponding to the first direction.

2. The touch-panel-integrated liquid crystal display of claim 1, further comprising:
a second comparator which comprises third and fourth nodes;
a second sensor line which is connected to the third node, extends in a same direction as the second lines, and transmits a touch signal corresponding to the second direction; and
a second decoupler which is connected between the fourth node and one of the second lines and decouples coupling noise present in the touch signal corresponding to the second direction.

3. The touch-panel-integrated liquid crystal display of claim 1, further comprising:
a second comparator which comprises third and fourth nodes;
a second sensor line which is connected to the third node, extends in a same direction as the second lines, and transmits a touch signal corresponding to the second direction; and
a dummy sensor line which is connected to the fourth node and extends in the same direction as the second lines.

4. The touch-panel-integrated liquid crystal display of claim 1, further comprising:
a second comparator which comprises third and fourth nodes;
a second sensor line which is connected to the third node, extends in a same direction as the second lines, and transmits a touch signal corresponding to the second direction;
a common electrode; and
a second decoupler which is connected between the fourth node and the common electrode, and decouples coupling noise present in a common voltage that is applied to the common electrode.

5. The touch-panel-integrated liquid crystal display of claim 1, wherein the first decoupler comprises a decoupling impedance.

6. The touch-panel-integrated liquid crystal display of claim 5, wherein the first decoupler comprises a decoupling resistor and a decoupling capacitor.

7. The touch-panel-integrated liquid crystal display of claim 1, further comprising a driver integrated circuit, wherein the first decoupler is installed in the driver integrated circuit.

8. The touch-panel-integrated liquid crystal display of claim 1, wherein the first lines, the second lines, the thin film transistors, the first comparator, the first sensor line, and the first decoupler are formed on a substrate.

9. A touch-panel-integrated liquid crystal display comprising:
a plurality of first lines which extend in a first direction;
a plurality of second lines which extend in a second direction that intersects the first direction;
a plurality of thin film transistors which are respectively disposed at interconnections between the first lines and the second lines;
a first comparator which comprises first and second nodes;
a first sensor line which is connected to the first node, extends in a same direction as the first lines, and transmits a touch signal corresponding to the first direction;
a common electrode; and
a first decoupler which is connected between the second node and the common electrode, and decouples coupling noise present in a common voltage that is applied to the common electrode.

10. The touch-panel-integrated liquid crystal display of claim 9, further comprising:
a second comparator which comprises third and fourth nodes;
a second sensor line which is connected to the third node, extends in a same direction as the second lines, and transmits a touch signal corresponding to the second direction; and
a second decoupler which is connected between the fourth node and the common electrode and decouples the coupling noise present in the common voltage.

11. The touch-panel-integrated liquid crystal display of claim 9, further comprising:
a second comparator which comprises third and fourth nodes;
a second sensor line which is connected to the third node, extends in a same direction as the second lines, and transmits a touch signal corresponding to the second direction; and
a dummy sensor line which is connected to the fourth node and extends in the same direction as the second lines.

12. The touch-panel-integrated liquid crystal display of claim 9, wherein the first decoupler comprises a voltage divider.

13. A touch-panel-integrated liquid crystal display comprising:
a plurality of first lines which extend in a first direction;
a plurality of second lines which extend in a second direction that intersects the first direction;
a plurality of thin film transistors which are respectively disposed at interconnections between the first lines and the second lines;
a first comparator which comprises first and second nodes;
a second comparator which comprises third and fourth nodes;
a first sensor line which is connected to the first node, extends in a same direction as the first lines, and transmits a touch signal corresponding to the first direction;
a second sensor line which is connected to the third node, extends in a same direction as the second lines, and transmits a touch signal corresponding to the second direction;
a first decoupler which is connected between the second node and one of the first lines and decouples coupling noise present in the touch signal corresponding to the first direction; and
a second decoupler which is connected between the fourth node and one of the second lines, and decouples coupling noise present in the touch signal corresponding to the second direction.

14. The touch-panel-integrated liquid crystal display of claim 13, further comprising a driver integrated circuit, wherein one of the first decoupler and the second decoupler is installed in the driver integrated circuit.

15. The touch-panel-integrated liquid crystal display of claim 13, further comprising a gate driver integrated circuit and a source driver integrated circuit wherein the first decoupler and the second decoupler are respectively integrated in the gate driver integrated circuit and the source driver integrated circuit.

16. The touch-panel-integrated liquid crystal display of claim 13, wherein the first lines, the second lines, the thin film transistors, the first comparator, the second comparator, the first sensor line, the second sensor line, the first decoupler, and the second decoupler are formed on a substrate.

17. A method of driving a touch-panel-integrated liquid crystal display, the method comprising:
providing a touch-panel-integrated liquid crystal display comprising a plurality of first lines which extend in a first direction, a plurality of second lines extend in a second direction that intersects the first direction, a plurality of thin film transistors which are respectively disposed at interconnections between the first lines and the second lines, a first comparator which comprises first and second nodes, a first sensor line which is connected to the first node, extends in the first direction, and transmits a touch signal corresponding to the first direction, and a first decoupler which is connected between the second node and one of the first lines and decouples coupling noise present in the touch signal corresponding to the first direction; and
applying external pressure to a touch panel of the touch-panel-integrated liquid crystal display, generating a signal which is a same as the coupling noise present in the touch signal corresponding to the first direction, and outputting the decoupled touch signal by applying the generated signal to an input terminal of the first comparator.

18. A method of driving a touch-panel-integrated liquid crystal display, the method comprising:
providing a touch-panel-integrated liquid crystal display comprising a plurality of first lines which extend in a first direction, a plurality of second lines extend in a second direction that intersects the first direction, a plurality of thin film transistors which are respectively disposed at interconnections between the first lines and the second lines, a first comparator which comprises first and second nodes, a first sensor line which is connected to the first node, extends in the first direction, and transmits a touch signal corresponding to the first direction, a common electrode, and a decoupler which is connected between the second node and the common electrode, and decouples coupling noise present in a common voltage that is applied to the common electrode; and
applying external pressure to a touch panel of the touch-panel-integrated liquid crystal display, reducing the common voltage, and outputting the decoupled common voltage by applying the reduced common voltage to an input terminal of the first comparator.
